(19) United States
(12) Patent Application Publication
(10) Pub. No.: US 2025/0145435 A1
(43) Pub. Date: May 8, 2025

(54) RACK STACKING SYSTEM

(71) Applicant: John Bean Technologies Corporation, Chicago, IL (US)

(72) Inventors: Donald Del Mar, Englewood, FL (US); William Poust, Perkasie, PA (US); Giacomo Gandini, Meadowbrook, PA (US); R. Scott Griffin, Langhorne, PA (US)

(73) Assignee: John Bean Technologies Corporation, Chicago, IL (US)

(21) Appl. No.: 18/930,758

(22) Filed: Oct. 29, 2024

Related U.S. Application Data
(60) Provisional application No. 63/596,543, filed on Nov. 6, 2023.

(51) Int. Cl. B66F 9/14; B66F 9/075

(52) U.S. Cl. CPC B66F 9/148; B66F 9/0755

(57) ABSTRACT

An attachment for a forklift for positioning a load includes a rearward carriage structure that supports a forward carriage structure to which forwardly extending forks are attached. The forward carriage structure is mounted to move side to side relative to the rearward carriage structure. Upright clamp arms are mounted to the forward carriage structure to move side to side toward and away from each other. Upper clamps are carried by the clamp arms to engage the exterior sides of a load being carried when the clamp arms are moved toward each other. Lower clamps are also carried by the clamp arms at a location below the upper clamps to engage the sides of a load positioned beneath load being carried by the forklift when moved toward each other and simultaneously moving the forward carriage structure to a medial (central) position between the clamp arms.

### CROSS-REFERENCE TO RELATED APPLICATION

This application claims the benefit of U.S. Provisional Application No. 63/596,543, filed Nov. 6, 2023, the entire contents of which are incorporated herein by reference.

### BACKGROUND

There is a need for forklifts, whether manned or unmanned (automated (AGV) or self-guided (SGV)), to be able to place loads in precise locations, including to stack loads on top of each other. One such need is to be able to stack metal racks on top of each other. Such metal racks typically have corner posts that slide into the corner post of the next above rack. The upper end of the corner post of the lower rack may be coned or otherwise tapered to help guide the upper rack into engagement with the lower rack. Nonetheless, the upper rack must be in substantially exact position over the lower rack for the tapered posts of the lower rack to correctly engage into to posts of the upper rack. This is difficult for a forklift operator to accomplish, especially since when the racks are above the level operator, it can be difficult to clearly see the locations of the corner posts of both the existing rack and the rack to be stacked on the existing rack. This has also been difficult to accomplish for unmanned forklifts, in part due to the preciseness required of the upper rack over the lower rack.

Attempts have been made to use camera based systems to position the rack over the beneath or lower rack. However, camera-based systems are sensitive to the level of ambient light and so are not reliable under low or marginal lighting conditions. Also, camera-based systems are programmed for a specific type of rack and must be reprogrammed for each specific type of rack being handled. This is an expensive and time consuming process.

The present disclosure seeks to provide a straightforward, reliable, and easy to implement and use forklift attachment, including for an AGV/SGV type of forklift, to accurately and expeditiously position a load in a desired location over a beneath or lower load, including positioning a storage rack over an existing rack.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an attachment is provided for a forklift for positioning a load at a desired location, the load having exterior sides. The attachment includes a rearward carriage structure, a forward carriage structure for supporting forwardly extending forks, the forward carriage structure slidably mounted on the rearward carriage structure to move side to side relative to the rearward carriage structure, upright clamp arms mounted to the forward carriage structure to move side to side relative to the forward carriage structure, toward and away from each other, upper clamps carried by the clamp arms to engage the exterior locations of a load being carried by the forks when the clamp arms are moved toward each other and simultaneously moving the forward carriage structure to a medial (central) position between the clamp arms.

In any of the embodiments described herein, further comprising lower clamps carried by the clamp arms at a location below the upper clamps to engage a load positioned beneath load being carried by the forklift.

In any of the embodiments described herein, wherein the upper and lower clamps are movable toward and way from each other.

In any of the embodiments described herein, wherein the lower clamps are movable toward and away from the upper clamps.

In any of the embodiments described herein, wherein the upright clamp arms comprising an upper segment on which the upper clamp arms are mounted and a lower segment on which the lower clamps are mounted.

In any of the embodiments described herein, wherein the upper and lower segments of the clamp arms are movable relative to each other to move the upper and lower clamps toward and away from each other.

In any of the embodiments described herein, further comprising a first actuator extending between the upper and lower segments of the clamp arms to move the upper and lower clamps toward and away from each other.

In any of the embodiments described herein, wherein the upper and lower clamps are disposed in vertical alignment with each other.

In any of the embodiments described herein, wherein the upper clamps and the lower clamps are configured to engage the posts of loads in the form of racks.

In any of the embodiments described herein, further comprising an actuator assembly for moving the clamp arms towards and away from each other.

In any of the embodiments described herein, wherein the actuator assembly is mounted to extend between the forward carriage plate and the clamp arms.

In any of the embodiments described herein, further comprising a locking mechanism to prevent relative sliding movement between the forward and rearward carriage structures.

In any of the embodiments described herein, further comprising a sensor for sensing the position of the attachment toward and away from the load.

In any of the embodiments described herein, wherein the upper clamps are configured to engage the posts of a load in the form of a rack

In accordance with another embodiment of the present disclosure, an attachment is provided for a forklift for positioning a load at a desired location above a lower structure, the load and the lower structure having exterior sides. The attachment includes a rearward carriage structure, a forward carriage structure for supporting forwardly extending forks, the forward and rearward carriage structures slidably engage with each other to move side to side relative to each other, upright clamp arms mounted to the forward carriage structure to move side to side relative to the forward carriage structure, toward and away from each other, upper clamps carried by the clamp arms to engage the exterior sides of a load being carried by the forks when the clamp arms are moved toward each other, lower clamp carried by the clamp arms to engage the exterior sides of the lower structure when the clamp arms are moved toward each other, and simultaneously moving the forward carriage structure to a medial (central) position between the clamp arms.

In any of the embodiments described herein, wherein the upper and lower clamps are movable toward and way from each other.

In any of the embodiments described herein, wherein the lower clamps are movable toward and away from corresponding upper clamps.

In any of the embodiments described herein, wherein the upright clamp arms comprising an upper segment on which the upper clamp arms are mounted and a lower segment on which the lower clamps are mounted.

In any of the embodiments described herein, wherein the upper and lower segments of the clamp arms are movable relative to each other to move the upper and lower clamps toward and away from each other.

In any of the embodiments described herein, further comprising a first actuator extending between the upper and lower segments of the clamp arms to move the upper and lower clamps toward and away from each other.

In any of the embodiments described herein, wherein the upper and lower clamps are disposed in vertical alignment with each other.

In any of the embodiments described herein, further comprising an actuator assembly for moving the clamp arms towards and away from each other.

In any of the embodiments described herein, wherein the actuator assembly is mounted to extend between the forward carriage plate and the clamp arms.

In any of the embodiments described herein, further comprising a locking mechanism to prevent relative sliding movement between the forward and rearward carriage structures.

In any of the embodiments described herein, further comprising a sensor for sensing the position of the attachment toward and away from the load.

In any of the embodiments described herein, wherein the upper clamps and the lower clamps are configured to engage the posts of loads in the form of racks.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of an embodiment of an attachment of the present disclosure as mounted on a forklift and carrying a load;

FIG. 2 is a view similar to FIG. 1 but taken from in front of the forklift;

FIG. 3 is a side elevational view of FIGS. 1 and 2 showing the attachment detached from the forklift;

FIG. 4 is the front elevation view of FIGS. 1 and 2;

FIG. 5 is an isometric view of the attachment taken from the front side thereof;

FIG. 6 is a view similar to FIG. 5, taken from the backside of the attachment;

FIG. 7 is a view similar to FIG. 5 but with the components of the attachment shown in exploded view;

FIG. 8 is a view similar to FIG. 7, taken from the backside of the attachment;

FIG. 9 is an enlarged fragmentary cross-sectional view taken along lines 9-9 of FIG. 5;

FIG. 10 is a view similar to FIG. 9, taken from the backside of the attachment;

FIG. 11 is an enlarged fragmentary view of the attachment taken from the backside thereof;

FIG. 12 is a further enlarged fragmentary view of a carriage locking system taken from the front side of FIG. 11.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “top,” “bottom,” “right hand,” “left hand,” “in,” “out,” “extended,” “advanced,” “retracted,” “proximal,” and “distal,” These references and other similar references in the present application are only to assist in helping describe and understand the present disclosure and are not intended to limit the present invention to these directions.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

The following description pertains to loads carried by a fork lift attachment. The load may be in numerous forms or structures, including rack sections, shelving sections, pallets with or without content, containers, or items such as machinery, building materials, raw materials, etc. Such structures and items shall be referred to loads with the understanding that the loads can take numerous forms. Also, typically such loads will include side or corner features that can be use as reference locations for the forklift attachment when positioning the load relative to the attachment as described herein.

The description of the present disclosure refers to a use of a forklift on which the attachment of the present disclosure is mounted. The forklift may be manned or unmanned. The unmanned forklifts can be of an automated or self-guided type, which are known as an AGV or an SGV. If the forklift is manned, it can be of the riding type or of a walk behind type.

In the following description, various embodiments of the present disclosure are described. Also, in the following description and in the accompanying drawings, the corresponding systems assemblies, apparatus, and units may be identified by the same part number, but with an alpha suffix. The descriptions of the parts/components of such systems assemblies, apparatus, and units that are the same or similar are not repeated so as to avoid redundancy in the present application.

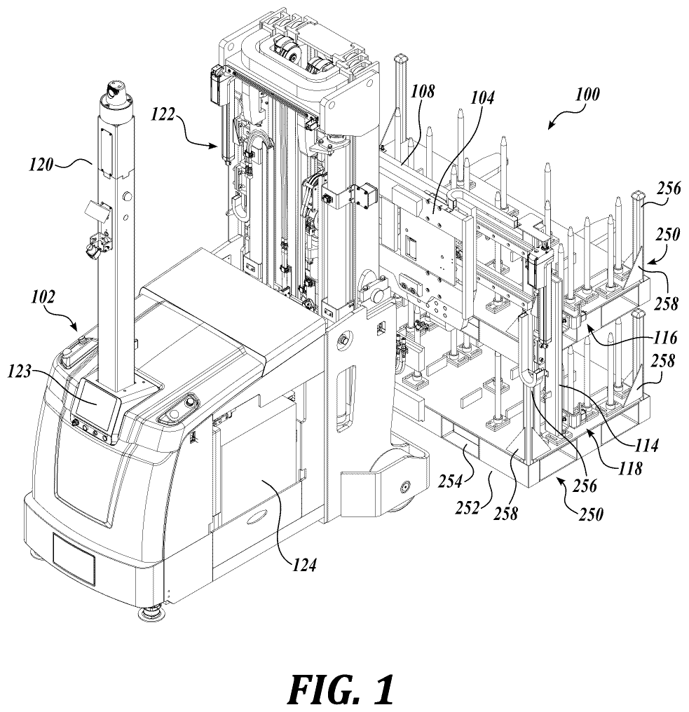

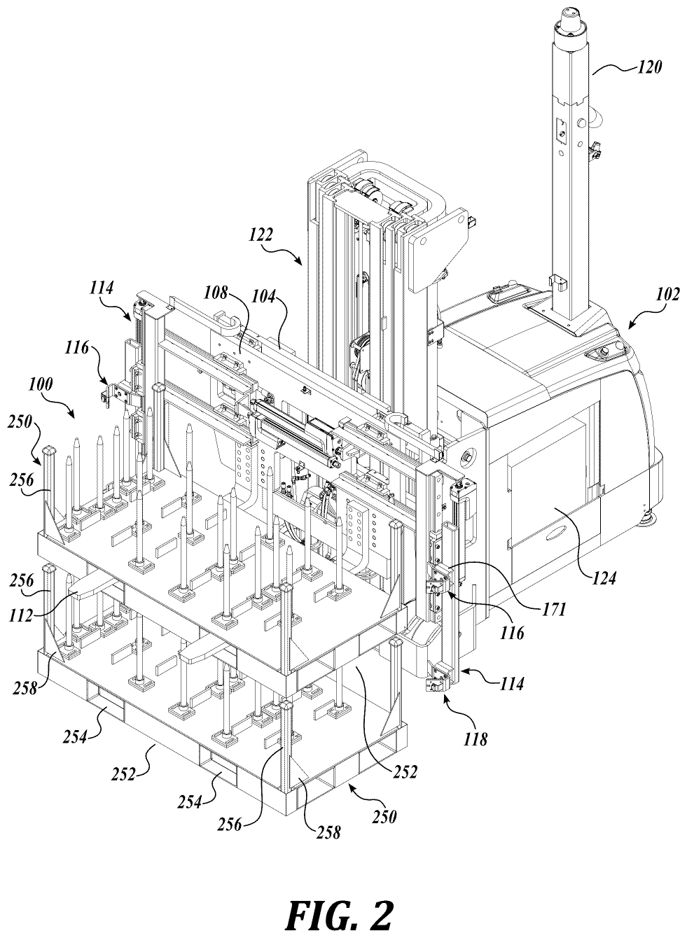

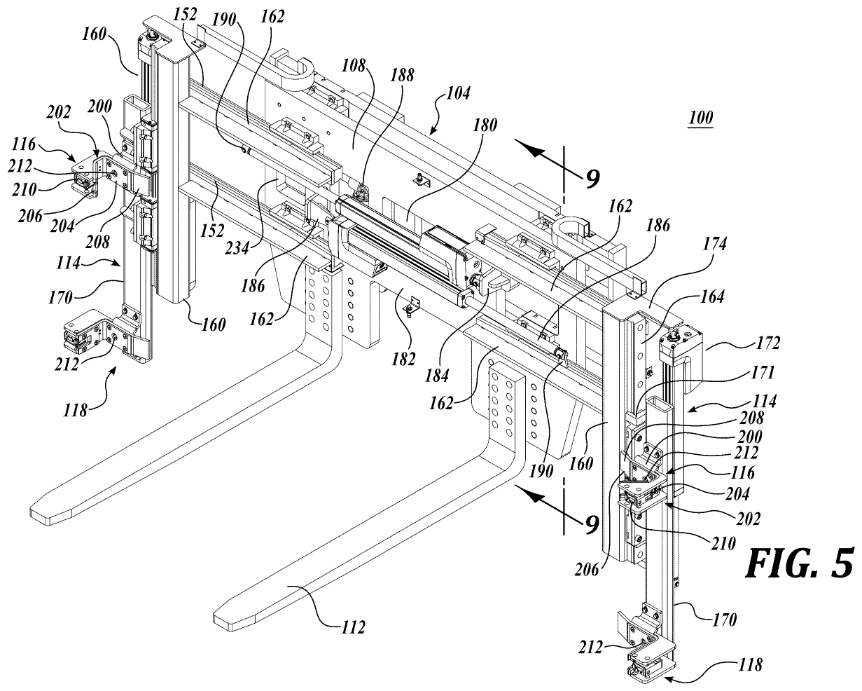

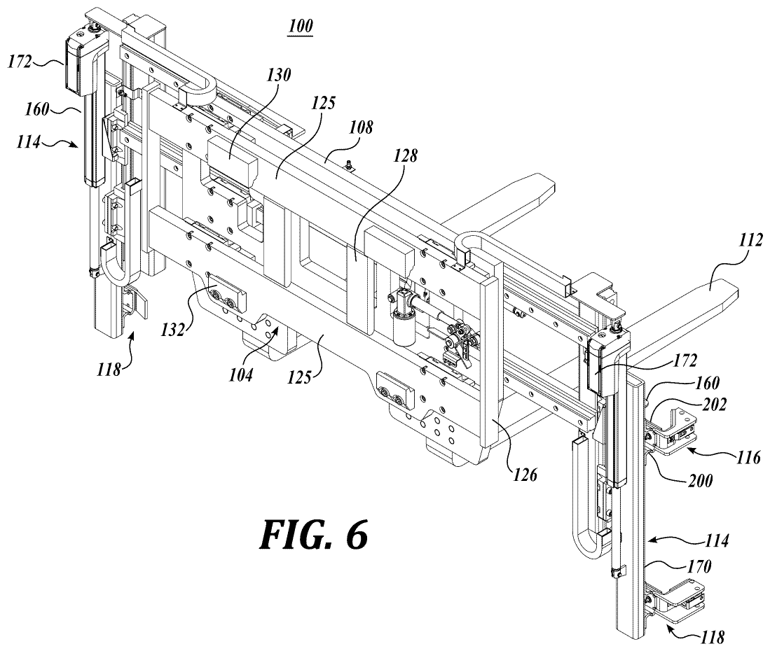

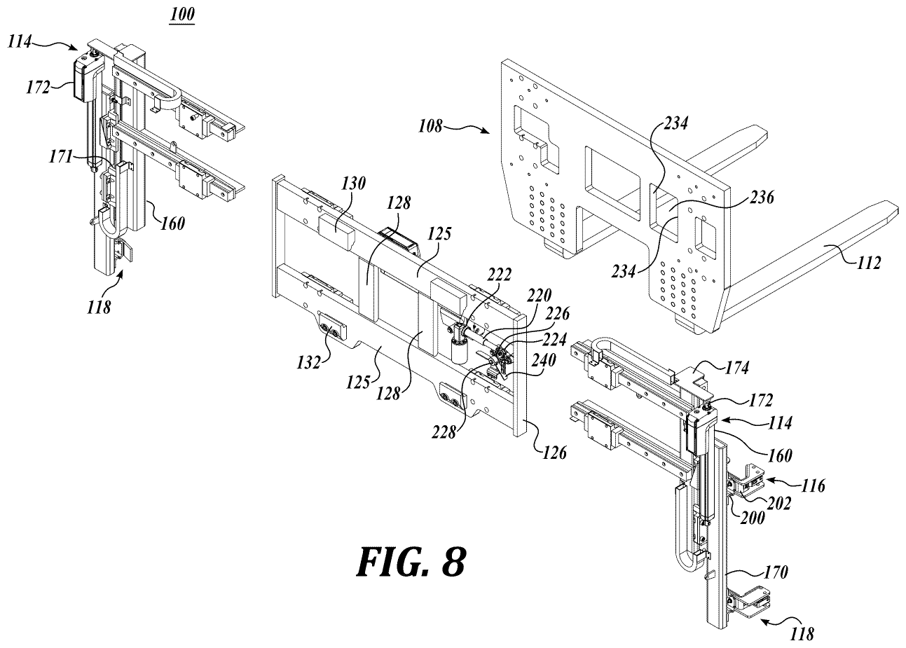

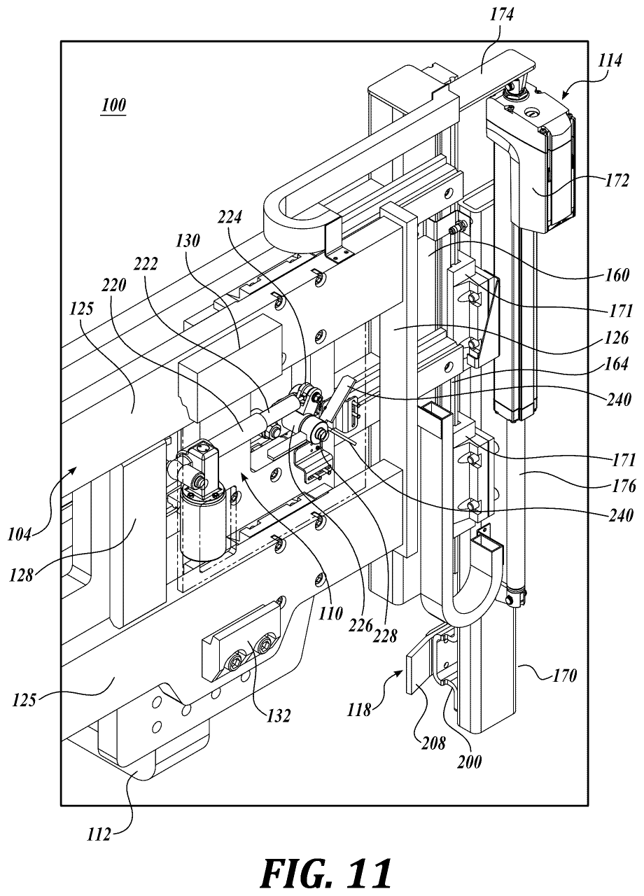

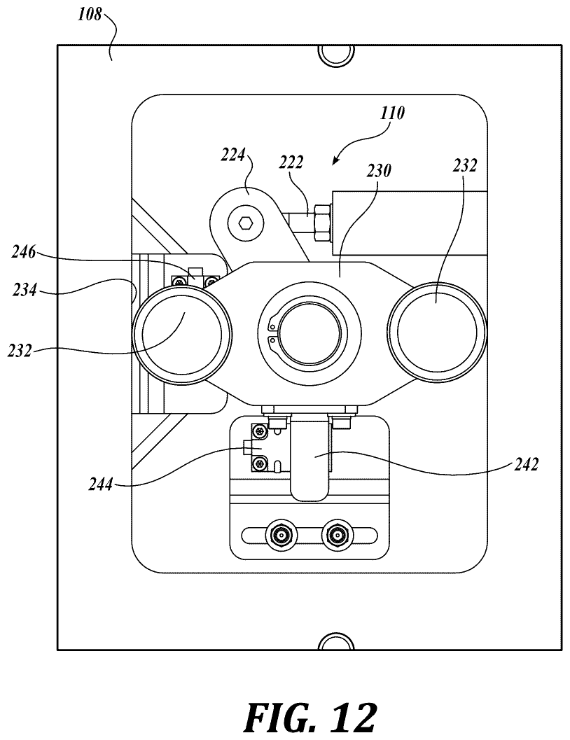

Referring initially to FIGS. 1 and 2, an attachment 100 constructed according to the present disclosure is shown as mounted on or associated with a forklift 102. Referring additionally to FIGS. 5-8, the attachment 100 includes in basic form a rear carriage structure 104 that is mountable to the forklift carriage 106. The attachment 100 also includes a forward carriage structure 108 mounted on the rearward carriage structure 104 for side-to-side movement relative to the forward carriage structure when permitted by a locking system 110, see FIGS. 11 and 12. Forks 112 are mounted on the forward carriage structure 108 to extend forwardly from the forward carriage structure.

Upright clamp arm assemblies 114 are mounted on the front sides of the forward carriage structure 108 for lateral movement across the forward carriage structure toward and away from each other. Upper clamps 116 are mounted on the upright clamp arm assemblies 114 for engagement with side locations of a load being carried by the forks 112. In a first use or operation of the attachment 100, if one of the upper clamps 116 engages the load before the other upper clamp, the load is shifted on the forks 112 toward the other upper clamp until both upper clamps 116 securely engage the load, thereby to center the load on the forks. This occurs with the forward carriage structure 108 locked with the rear carriage structure 104.

In a second use or operation of the attachment 100, if the forward carriage structure is unlocked from the rear carriage structure, the closing of the clamp arms towards each other will cause the forward carriage structure to shift or slide relative to the rear carriage structure toward the upper clamp that first engages the load, rather than slide the load on the forks. In this manner, the load is centered between the closed clamp arms.

Lower clamps 118 are mounted on the upright clamp arm assemblies 114 beneath a corresponding upper clamp 116 to engage side locations of the load located beneath the load being carried by the forks 112. The attachment 100 is able to precisely laterally locate the load being carried by the forks over the beneath load. In this regard, the upright clamp arm assemblies 114 are initially positioned (opened) so the upper clamps 116 and lower clamps 118 are outward of the beneath load.

With the rear and forward carriage structures unlocked relative to each other, the upright clamp arm assemblies 114 are actuated to move toward each other. If one of the lower clamps 118 engages the beneath load before the other lower clamp, then lateral movement of the engaged lower clamp stops and the lateral movement of the other lower clamp continues until this clamp engages the beneath load. During this continued lateral movement, the forward carriage structure shifts relative to the rear carriage structure toward the first engaged lower clamp. The load being carried by the forks also moves with the forward carriage, to be centered between the upright clamp assemblies. As a result, the load being carried is brought into alignment with the beneath load. As will be appreciated, the lower clamps serves as locating or centering guides for the load being carried by the attachment.

It is to be understood that notwithstanding the description of the attachment 100 herein, the present invention need not include all of the components or capabilities of the attachment 100 described herein. Further, the present invention may be directed to a portion or a component of the attachment 100 described herein.

To expand on the foregoing disclosure, the operation of the forklift 102 can be automated, so that no human driver is used. In this regard, the forklift includes an onboard navigation system to control the travel paths of the forklift. Components of the navigation system may be located on the navigation post 120 extending upwardly from the body of the forklift. The navigation system may be, for example, optically, radar and/or Lidar based.

Other operations or functions of the forklift 102 may be automatically performed, including, for example, the raising and lowering of the telescoping mast 122 and the operation of the attachment 100. The forklift may include a HUI 123 that can be used to program the forklift and to check and monitor the operation and condition of the forklift, for example, the level of charge of the battery 124 used to power the forklift.

Of course, other types of forklifts can be used in conjunction with the attachment 100, including manned forklifts. Typically each such forklift will include a mast and carriage attached to the mast.

Describing the attachment 100 in more detail, the rear carriage structure 104 includes upper and lower cross beams 125 tied together at their ends by vertical end plates 126. The crossbeams 125 are also tied together intermediate their ends by vertical beams 128, thereby achieving a rigid structure. Upper mounting blocks 130 are attached to the backside of the upper cross beam 125, and lower mounting blocks 132 are attached to the backside of the lower crossbeam 125. The mounting blocks 130 and 132 engage upper and lower mounting rails 134 and 136 extending across the lift truck carriage 106 in a standard manner.

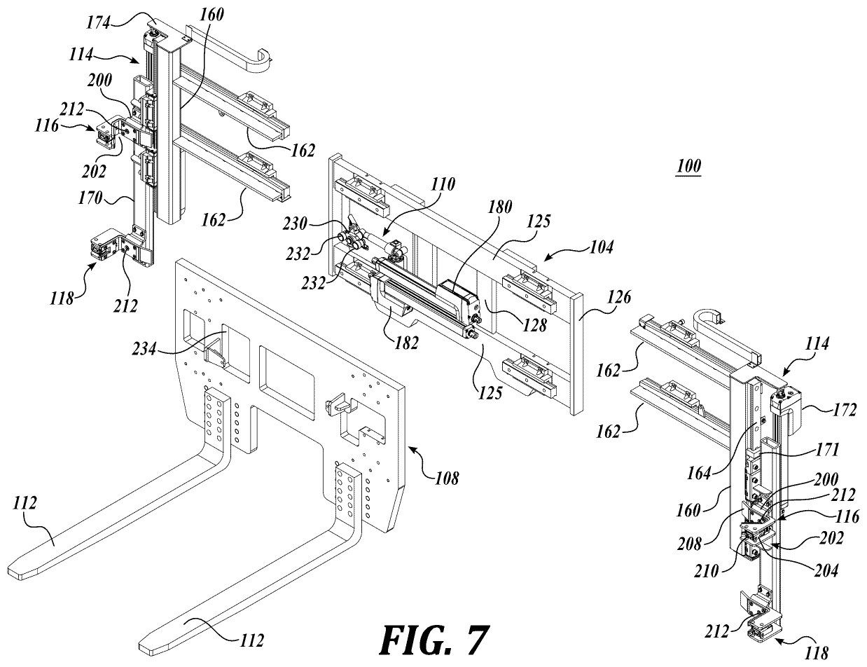

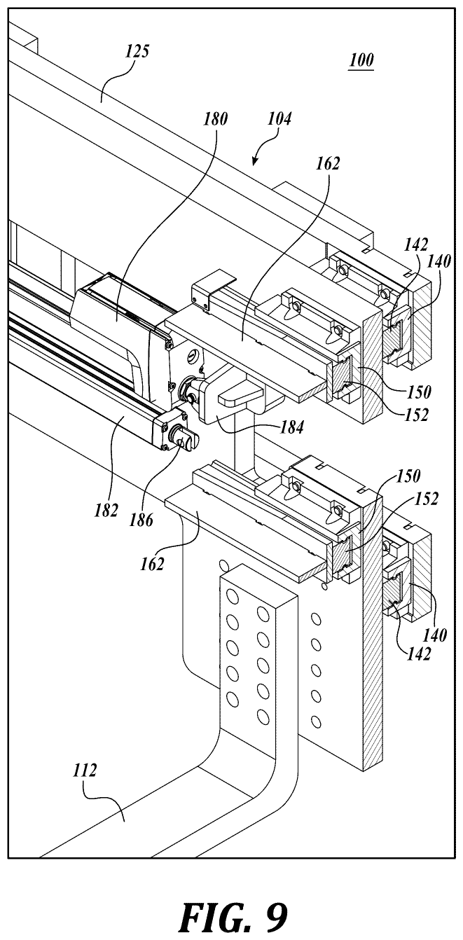

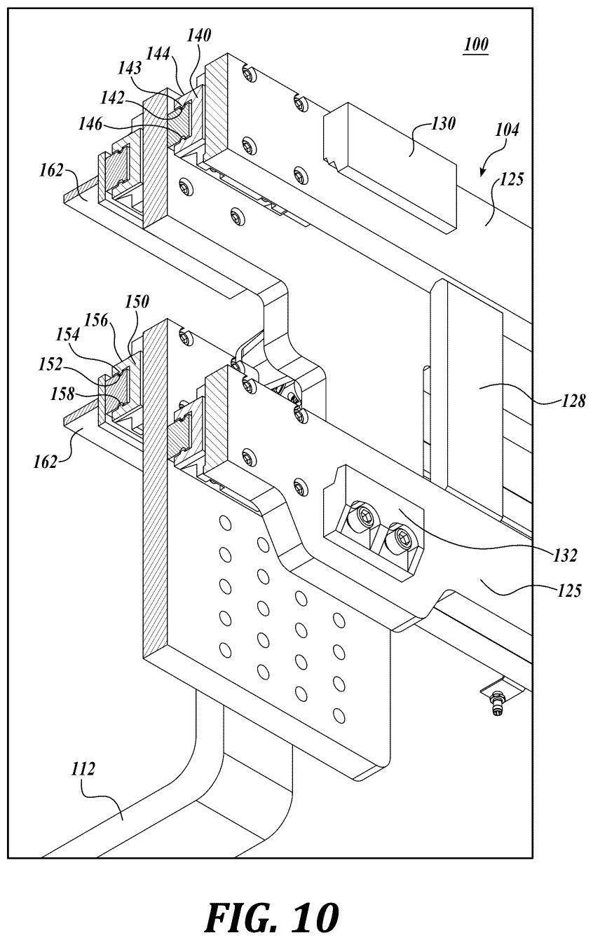

Referring to FIGS. 7, 9, and 10, U-shaped or channel-shaped slideways 140 are mounted on the front sides of crossbeams 125 to receive elongated slides 142 mounted to the backside of the forward carriage structure 108 to enable the forward carriage structure to slide laterally relative to the rear carriage structure 104 as described herein. The slides 142 remain engaged with the corresponding slideways 140 by elongate ridges 143 extending along the upper and lower flange portions 144 of the slideways 140. The ridges 143 engage within close fitting elongate grooves 146 extending along the upper and lower surfaces of the slides 142. Of course, other means can be used to retain the slides 142 engaged within the slideways 140.

Referring specifically to FIGS. 7-10, the forward carriage structure 108 is in the form of a unitary plate. The forks 112 are mounted to the front side of the fork carriage structure 108 with standard hardware members. The forks 112 can be positioned on the forward carriage structure at various locations to alter the separation between the forks 112.

U-shaped or channel-shaped slide ways 150 are mounted on the forward face of the forward carriage structure 108 to receive elongated slides 152 that form a portion of the upright clamp arm assemblies 114, whereby the clamp arm assemblies are movable across the forward carriage structure 108. The slides 152 remain engaged with a corresponding slide way 150 by elongate ridges 154 extending along the upper and lower flange portions 156 of the slide ways 150. Such ridges 154 engage within close fitting elongate grooves 158 extending along the upper and lower surfaces of the slides 152. Of course, other means can be used to retain the slides 152 engaged within the slide ways 150.

In construction, the upright clamp arm assemblies 114 include an upright post structure 160 that is attached to the outward ends of horizontal plates 162 that project horizontally from the post structure across the front side of the forward carriage structure 108. The slides 152 are attached to the edges of the horizontal plates 162, to thereby form a rigid structure with the post structure 160.

An elongated slide 164 extends vertically along the outer surface of the post structure 160. A vertically movable lower post 170 is movable along the slide 164. U-shaped or channel-shaped slide ways 171 are fixed to the lower post 170 and slightly engage the slide 164.

A linear actuator 172 extends downwardly from a bracket 174 projecting laterally outwardly from the upper ends of upright post structure 160. The linear actuator includes an extendable/retractable actuator rod 176 which is connected to a lower portion of the lower post 170 to raise or lower the lower post.

The upright clamp assemblies 114 are powered to move laterally across the front side of the forward carriage structure 108. This movement is accomplished by the use of upper and lower linear actuators 180 and 182. The upper linear actuator 180 powers right hand upright clamp assembly 114 when viewed from behind the forklift, and the lower linear actuator 182 power the left hand upright clamp assembly 114 when viewed from behind the forklift. The bodies or stationary portions of the linear actuators 180 and 182 are attached to the forward carriage structure 108. A bracket 184 projects forwardly from the forward carriage structure 108 to which the body of the linear actuator 180 is affixed. Likewise, a bracket 186 projects forwardly form the forward carriage structure 108 to which the body of the linear actuator 182 is affixed. Extendable and retractable actuator rods 188 project from the body/stationary portions of the linear actuators 180 and 182 to connect with anchor brackets 190 attached to one of the slides 150 of an upright clamp arm assembly.

As perhaps best shown in FIGS. 5-8, upper clamps 116 are mounted on the post structures 170 of the upright clamp arm assemblies 114. The upper clamps 116 include a formed bracket 200 projecting forwardly from the post structures 116 to which is mounted a formed receiving member 202. The receiving member 202 includes a base portion 204 affixed to the bracket 200 and a lead-in section 206 projecting forwardly and laterally inwardly from laterally outward side of the base portion 204 to cooperate with the base portion to form a generally V-shaped pocket for engaging the side portions of a load, for example, the corner post of a rack. A lead in section 208 can also project from the opposite inward side of the base portion 204 to help feed the load into the clamp pocket.

An optical sensor 210 is mounted on the lead in sections 206 of the upper clamps 116 to project laterally across the attachment 100 toward the opposite upper clamp 116. This manner, the optical sensor 210 can sense the presence of a load as the attachment is moved forwardly to the load. For example, if the load is in the form of a rack having corner posts, as the attachment moves towards the rack, the optical sensor 210 can sense the near side of the post. Then, as the attachment moves further forwardly, the optical sensor can sense the far side of the post. The clamps 116 are then in position to capture the corner posts within the pockets of the clamps when the upright clamp arm assemblies 114 are closed inwardly against the corner posts. The sensors 210 may be in the form of lasers, but can be of other types of optical sensors. Further, other types of sensors can be used, including for example sonar sensors.

Sensors 212 are also located in the base portions 204 of the formed brackets 200. See FIGS. 5 and 7. The sensors 212 detect whether the rack posts 256 (described below) are fully engaged with the clamps 116. The sensors 212 can be of various types of proximity sensors or sensors of other types.

As shown in FIGS. 5-8, lower clamps 118 are mounted on the lower posts 170 at a location vertically beneath a corresponding upper clamp 116. The lower clamps 118 are constructed similarly to the upper clamps 116; however, the lower clams 118 are in the shape of an right angle rather than in the form of the V-shaped pocket of the upper clamps. As such, the description of the lower clamps 118, including the associated optical and proximity sensors, will not be repeated here.

Next referring specifically to FIGS. 7, 8, 11, and 12, the locking system 110 includes a linear actuator 220 mounted on the rear carriage structure 104. The extendable/retractable rod portion 222 of the linear actuator is pivotally attached to an arm 224 extending radially from a collar 226 that is pivotally mounted on a shaft 228 mounted to the rear carriage structure 104. As shown, including in FIG. 11, paddles 240 project radially outwardly from shaft 228 to provide structure and support of the shaft.

A swing arm 230 extends transversely from the forward end of the collar 226. A pair of rollers 232 are mounted to the ends of the swing arm 230. With the extension and retraction of the linear actuator 220, the rollers are rotated between a horizontal position relative to each other and a vertical position relative to each other.

When the rollers 232 are in horizontal position relative to each other, as shown in FIG. 12, they engage the side edges 234 of an opening 236 formed in the forward carriage structure plate 108, thereby to lock the rear carriage structure 104 with the forward carriage structure 108. It will be appreciated that when this locking occurs, the forward carriage structure 108 does not need to be centered relative to the rear carriage structure 104.

When the rollers 232 are in vertical position relative to each other, the forward carriage structure 108 is allowed to move side to side relative to the rear carriage structure 104. The amount of such movement equates to the distance separating the rollers 232 from the side edges 234 of the forward carriage structure plate opening 236.

The rotation position of the rollers 232 can be sensed to thereby know whether or not the forward carriage structure 108 is locked relative to the rear carriage structure 104. As described herein, particular operations with the attachment 100 are performed when the forward carriage structure 108 is locked relative to the rear carriage structure 104, and other operations are performed when the forward carriage structure 108 is not locked relative to the rear carriage structure 104.

Referring to FIG. 12, a flag bracket 242 projects form the swing arm 230. When the rollers 232 are in horizontal position, the flag bracket projects downwardly from the swing arm 230 and this position of the flag bracket is sensed by optical sensor 244. When the rollers 232 are in vertical position, the flag bracket 242 projects from the swing arm horizontally to the left, and this position of the flag bracket is sensed by optical sensor 246. In this manner, it is known whether the locking system 110 is engaged or not.

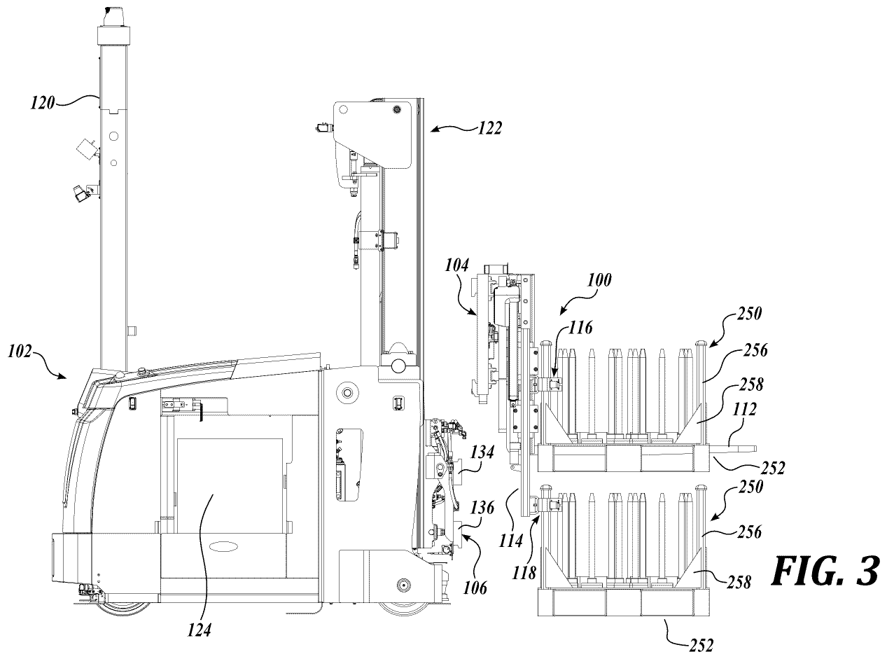

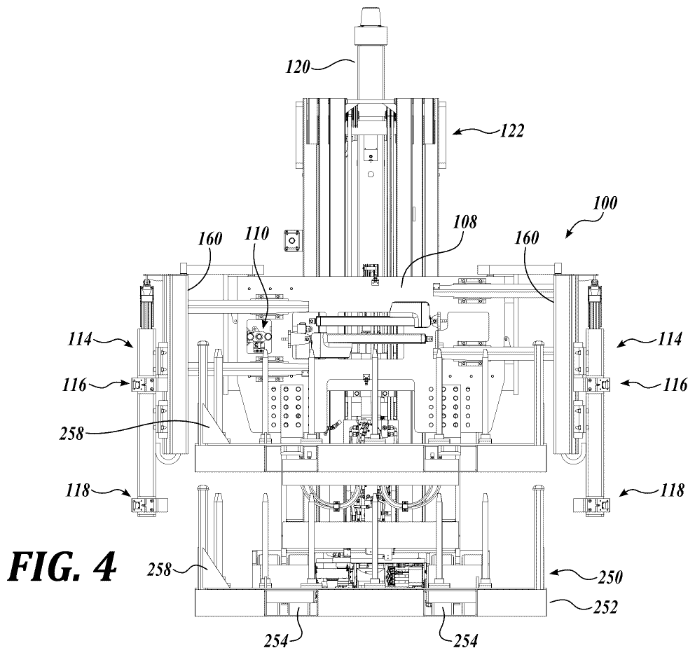

One non-limiting example of the use of the attachment 100 of the present disclosure will be provided in conjunction with the stacking of racks 250 as shown in FIGS. 1-4. The rack 250 includes a base structure 252 having pockets 254 formed therein for the reception of forks 112. A corner post 256 extends upwardly from each corner of the base structure 252. Triangularly shaped reinforcing or gusset plates 258 extend between the corner posts 256 and the top surface of the base structure 252. The upper ends of the corner post 256 are tapered or pointed so as to provide a lead-in when a rack 250 is lowered on to a lower rack. The upper ends of the corner posts of the lower rack engage into sockets located in the underside of the upper rack or into to the lower ends of a corner posts of the upper rack.

Of course, as noted herein, other types of loads may be carried and positioned using the attachment 100 of the present disclosure. The rack 250 is simply one example of a load that the attachment 100 of the present disclosure is capable of carrying and positioning.

To pick the rack 250 from the floor, the lower posts 170 of the upright clamp arm assemblies 114 are retracted to full upward position relative to the post structure 160. The clamp arm assemblies 114 are opened or spread apart wide enough to allow the rack 250 to be picked (forks 112 engaged with the rack 250) without interference by the clamp arm assemblies. After the rack 250 is picked, the forks are raised. If both the upper and lower clamps 116 and 118 are able to engage the rack corner posts, the clamp arm assemblies are closed towards each other to center the rack 250 on the forks 112. Note that the forward carriage structure 108 is locked with respect to the rear carriage structure 104.

If the rack 250 will not accept both the upper and lower clamps 116 and 118, the lower posts 170 are lowered so that the lower clamps 118 are lowered sufficiently to clear the bottom of the rack 250. Thereafter, the clamp arm assemblies 114 are closed towards each other to center the rack 250 on the forks 112.

Thereafter, the clamp arm assemblies 114 are opened or spread apart, and then the lower clamp arms are raised to clear the bottom of the rack 250. The forklift is now in travel condition. Note that it may be possible to travel with the rack 250 clamped by the upper clamps 116 or perhaps clamped by both the upper and lower clamps 116 and 118.

To pick the rack 250 off of a lower or beneath rack, the lower clamps 118 are retracted to their full up position. The upright clamp on resembles 114 are opened or spread apart far enough to allow the rack 250 to be picked without interference by the upright clamp arm assemblies. The rack is raised upward off the lower rack after picking. Then the forklift is backed out from the lower rack, and the upper clamps 116 are moved towards each other or otherwise closed together to center the rack 250 on the forks 112. It will be noted that the forward carriage structure 108 is locked relative to the rear carriage structure 104. If both the upper and lower clamps can engage the corner post of the rack 250, both the upper and lower clamps can be used two center the rack 250 on the forks 112. The forklift is now ready for travel if required.

To place a rack 250 on the floor, the lower clamps 118 are raised to their full up position. In addition, the upright clamp arm assemblies 114 are opened (spread apart) far enough to allow the rack 250 to be lowered on to the floor without interference from the upright clamp arm assemblies. It will be noted that the forward carriage structure 108 is locked relative to the rear carriage structure 104.

To place a rack 250 on to a lower or beneath rack, the rack must be precisely positioned over the lower rack. To this end, the upright clamp arm assemblies 114 are spread apart or opened sufficiently to clear the racks. Thereafter, the lower clamps 118 are lowered sufficiently to engage the posts of the lower or beneath rack. The forklift is advanced forwardly relative to the lower rack so that the sensors 210 of the upper and lower clamps 116 and 118 become blocked due to first sensing the rack posts and then become unblocked. This indicates that the racks are in proper position in the forward direction relative to the lengths of the forks 112.

Next, the forks are lowered until the rack 250 is about 3 inches above the lower or beneath rack. Next, the locking system is actuated to unlock the forward carriage structure relative to the rear carriage structure 104. As such, the forward carriage structure 108 is now free to float side to side relative to the rear carriage structure 104. Next, the upright clamp arm assemblies 114 are moved towards each other. When the first lower clamp 118 engages against the post of the lower or beneath rack, that lower clamp ceases to move any further laterally. Rather, the applicable upper or lower linear actuator 180 or 182 will cause the forward carriage structure to slide in the lateral direction toward that lower clamp 118 that has first engaged the post of the lower rack. At the same time, the other lower clamp 118 continues to move towards its corresponding post of the lower or beneath rack. Once the other lower clamp 118 engages its corresponding rack post, the rack 250 is now in alignment with the lower or beneath rack. All of the proximity sensors 210 and 212 now detect the two upper rack posts and the two lower rack posts.

Next, the upright clamp arm assemblies 114 are opened slightly to reduce wear and tear on the racks while lowering the upper rack onto the lower rack. In this regard, as the upper rack is lowered, the clamps 118 need to lower relative to the corner posts of the lower rack. If the upright clamp arm assemblies are not opened slightly, then the clamps 118 are forced to slide downward when pressing against the corner posts of the lower rack. This can result in scraping against the corner posts. The upper rack is then lowered onto the beneath rack.

Thereafter, the upright clamp arm assemblies 114 are opened (spread apart) to disengage the clamps 116 and 118 from the racks. Next, the lower posts 170 are retracted upwardly and then the forklift can be retracted away from the rack 250 that has just lowered into place. Thereafter, the locking system 110 is actuated to lock the forward carriage structure relative to the rear carriage structure.

It will be appreciated that the electro-mechanical attachment 100 disclosed herein provides for a straightforward, uncomplicated, and reliable system for accurately positioning a load at a desired location, for example, over a load beneath. One specific, but not limiting, use of the attachment 100 is to stack storage racks on top of each other. Such racks are used in number manufacturing industries to position components in desired position on a production line, such as an automotive or a vehicle or an equipment production line.

While illustrative embodiments have been illustrated and described, it will be appreciated that various changes can be made therein without departing from the spirit and scope of the invention.

Although the present disclosure has been described in conjunction with a rack 250, it is to be understood that the attachment can be adapted for use with racks of other constructions, as well as other types of loads, for example, a container or pallet. In these situations, the upper and lower clamps can engage applicable structural features of the container or pallet, such as a corner of the container or pallet. As such, the clamps can be appropriately designed based on the structural feature of the load being handled.

The various linear actuators described herein can be powered by various means, including, for example, electrically, pneumatically, or hydraulically.

Also, in the figures, the hydraulic, pneumatic and/or electrical lines to the various linear actuators are not shown, it is to be understood that the routing of such lines to the linear actuators from a source on the forklift 102 is a matter of routine for one skilled in the art.

FIGS. 1-4 illustrate one example of a forklift 102 for use with the attachment 100. It is to be understood that the forklifts of other configurations, whether manned or unmanned, can be used in conjunction with attachment 100.

1. An attachment for a forklift for positioning a load at a desired location, the load having exterior sides, the attachment comprising:
a rearward carriage structure;
a forward carriage structure for supporting forwardly extending forks, the forward carriage structure slidably mounted on the rearward carriage structure to move side to side relative to the rearward carriage structure;
upright clamp arms mounted to the forward carriage structure to move side to side relative to the forward carriage structure, toward and away from each other;
upper clamps carried by the clamp arms to engage the exterior locations of a load being carried by the forks when the clamp arms are moved toward each other and simultaneously moving the forward carriage structure to a medial (central) position between the clamp arms.

2. The attachment of claim 1, further comprising lower clamps carried by the clamp arms at a location below the upper clamps to engage a load positioned beneath load being carried by the forklift.

3. The attachment of claim 2, wherein the upper and lower clamps are movable toward and way from each other.

4. The attachment of claim 2, wherein the lower clamps are movable toward and away from the upper clamps.

5. The attachment of claim 2, wherein the upright clamp arms comprising an upper segment on which the upper clamp arms are mounted and a lower segment on which the lower clamps are mounted.

6. The attachment of claim 5, wherein the upper and lower segments of the clamp arms are movable relative to each other to move the upper and lower clamps toward and away from each other.

7. The attachment of claim 2, wherein the upper and lower clamps are disposed in vertical alignment with each other.

8. The attachment of claim 1, further comprising an actuator assembly for moving the clamp arms towards and away from each other.

9. The attachment of claim 8, wherein the actuator assembly is mounted to extend between the forward carriage plate and the clamp arms.

10. The attachment of claim 1, further comprising a locking mechanism to prevent relative sliding movement between the forward and rearward carriage structures.

11. The attachment of claim 1, further comprising a sensor for sensing the position of the attachment toward and away from the load.

12. The attachment of claim 1, wherein the upper clamps are configured to engage the posts of a load in the form of a rack.

13. An attachment for a forklift for positioning a load at a desired location above a lower structure, the load and the lower structure having exterior sides, the attachment comprising:
a rearward carriage structure;
a forward carriage structure for supporting forwardly extending forks, the forward and rearward carriage structures slidably engage with each other to move side to side relative to each other;
upright clamp arms mounted to the forward carriage structure to move side to side relative to the forward carriage structure, toward and away from each other;
upper clamps carried by the clamp arms to engage the exterior sides of a load being carried by the forks when the clamp arms are moved toward each other;
lower clamps carried by the clamp arms to engage the exterior sides of the lower structure when the clamp arms are moved toward each other, and simultaneously moving the forward carriage structure to a medial (central) position between the clamp arms.

14. The attachment of claim 13, wherein the upper and lower clamps are movable toward and way from each other.

15. The attachment of claim 13, wherein the lower clamps are movable toward and away from corresponding upper clamps.

16. The attachment of claim 13, wherein the upright clamp arms comprising an upper segment on which the upper clamp arms are mounted and a lower segment on which the lower clamps are mounted.

17. The attachment of claim 16, wherein the upper and lower segments of the clamp arms are movable relative to each other to move the upper and lower clamps toward and away from each other.

18. The attachment of claim 13, wherein the upper and lower clamps are disposed in vertical alignment with each other.

19. The attachment of claim 13, further comprising an actuator assembly for moving the clamp arms towards and away from each other.

20. The attachment of claim 13, further comprising a sensor for sensing the position of the attachment toward and away from the load.

21. The attachment of claim 13, wherein the upper clamps and the lower clamps are configured to engage the posts of loads in the form of racks.
